(19) United States
(12) Patent Application Publication
(10) Pub. No.: US 2025/0042743 A1
(43) Pub. Date: Feb. 6, 2025

(54) A METHOD OF REDUCING A GASEOUS CARBON OXIDE

(71) Applicant: ROYAL MELBOURNE INSTITUTE OF TECHNOLOGY, Melbourne (AU)

(72) Inventors: Torben Jost Daeneke, Melbourne (AU); Ken Kin Kwong Chiang, Melbourne (AU); Karma Rafiq Mohammad Zuraiqi, Melbourne (AU)

(21) Appl. No.: 18/709,451

(22) PCT Filed: Nov. 10, 2022
(86) PCT No.: PCT/AU2022/051337

§ 371 Date: May 10, 2024

(30) Foreign Application Priority Data
Nov. 10, 2021 (AU) 2021903596

(51) Int. Cl. C01B 32/05; B01J 10/00; B01J 19/06

(52) U.S. Cl. CPC C01B 32/05; B01J 10/002; B01J 10/005; B01J 19/06

(57) ABSTRACT

The invention provides a method of reducing a gaseous carbon oxide to carbon, the method comprising mixing a gas comprising a gaseous carbon oxide with a liquid metallic composition by producing a dynamic interface between the gas and the liquid metallic composition, wherein the liquid metallic composition is not dispersed as droplets in a liquid carrier during the mixing and wherein the gaseous carbon oxide reacts stoichiometrically with at least one metal in the liquid metallic composition to form carbon and metal oxide.

### PRIORITY CROSS-REFERENCE

The present invention claims priority from Australian provisional patent application No. 2021903596 filed on Oct. 11, 2021, the contents of which should be understood to be incorporated into this specification by this reference.

### TECHNICAL FIELD

The invention relates to a method of reducing a gaseous carbon oxide, such as carbon dioxide, to carbon. The method comprises mixing a gas comprising the gaseous carbon oxide with a liquid metallic composition so that the gaseous carbon oxide reacts stoichiometrically with a metal in the liquid metallic composition to form carbon and metal oxide. The invention also relates to a system for reducing a gaseous carbon oxide to carbon.

### BACKGROUND OF INVENTION

Given the urgent need to reduce greenhouse gas emissions, it is desirable to develop technologies for converting carbon dioxide into environmentally benign and potentially economically valuable products, such as solid carbon. However, direct decomposition of carbon dioxide to carbon is challenging due to the unfavourable thermodynamics of this transformation. Thermal decomposition of the highly stable carbon dioxide molecule requires a substantial input of energy and reaction temperatures in excess of 2000 K.

A significant effort has previously been made to reduce the required reaction temperature of the carbon dioxide decomposition reaction using heterogeneous catalysts. Despite some advances, for example using oxygen-deficient metal oxide-based catalysts, a practical implementation has not been realised because of low conversions, rapid deactivation of the solid catalysts due to coking and the challenge of separating the solid carbon product from the catalyst.

Liquid metals, which are less susceptible to coking, have previously been used to facilitate catalytic decomposition of carbon dioxide to carbon. In an electrocatalytic approach, as reported by Esrafilzadeh in Nature Communications 2019, 10, 865, a liquid metal cathode was used to reduce carbon dioxide dissolved in a molecular liquid electrolyte. However, carbon dioxide conversion could only be obtained by including an oxidation-susceptible metal (cerium) in the liquid metal composition and continuously regenerating the oxidised metal by-product, which accumulated on the liquid metal cathode surface, to metallic form by electrochemical reduction.

In another approach, as reported by Tang et al in Adv. Mater. 2021, 2105789, mechanical energy was used to disperse droplets of liquid metal in a molecular liquid containing dissolved carbon dioxide, decompose the carbon dioxide to carbon on the surface of the droplets, and continuously reduce the metal oxide by-product accumulating on the surface of the liquid metal droplets in a triboelectrochemical reduction process which relied on the presence of a solid co-contributor (gallium-silver rods) in the reaction medium. The components at the surface of the dispersed droplets thus operated as a catalytic system within the reactor to convert carbon dioxide in situ to carbon and molecular oxygen (O₂). In the absence of either the solid co-contributor or continuous mechanical energy input (via sonication), no carbon dioxide conversion was obtained.

While these processes are theoretically interesting, a practical process for carbon dioxide decomposition would ideally involve a simple chemical reaction which does not require electrical or mechanical energy inputs sufficient to drive an electrocatalytic or triboelectrochemical reaction mechanism. Such a process could be implemented in a simple chemical reactor and operated under process conditions which are unconstrained by the need for molecular liquid carriers or the requirement to continuously regenerate an oxidised reaction by-product.

Carbon monoxide is a toxic gas which must be removed from gas streams in many applications for safety reasons. Carbon monoxide is more reactive than carbon dioxide, and a greater range of options are thus available to process this molecule. Nevertheless, it would also be desirable to develop technologies for converting carbon monoxide to carbon which avoid the deactivation, separation and process complexity issues associated with the use of solid catalysts or (tribo) electrochemically mediated reaction mechanisms.

There is therefore an ongoing need for methods of reducing gaseous carbon oxides such as carbon dioxide and carbon monoxide to carbon, which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

The inventors have now discovered that gaseous carbon oxides, including carbon dioxide and carbon monoxide, can be directly decomposed to carbon by contacting a gas containing the carbon oxide with a liquid metallic composition, i.e. a reduced metal or metal alloy composition in its molten state, under conditions where a dynamic interface between the gas and the liquid metallic composition is provided. A metal element present in the liquid metallic composition thus reacts stoichiometrically with the carbon oxide, producing solid carbon with accompanying formation of a metal oxide by-product.

The dynamic interface between the liquid and gas phases can be produced by any suitable method, such as bubbling the gas through the liquid metal composition, mechanically agitating the liquid metal composition in the presence of the gas, spraying droplets of the liquid metal composition through the gas and the like. Without wishing to be bound by any theory, it is proposed that this approach avoids or mitigates the issues associated with accumulation of inertizing by-products on either a solid interface (e.g. a solid catalyst) or liquid metal interface (e.g. on the comparatively static surfaces of a liquid metal cathode or dispersed liquid metal droplet). Instead, fresh liquid metal is continuously exposed at a pristine liquid-gas interface and the solid by-products, including the carbon and metal oxide, are automatically disengaged.

The approach disclosed herein avoids or mitigates a number of the difficulties associated with catalytic decomposition of carbon oxides on solid catalysts. Firstly, the thermodynamics are significantly favoured over the catalytic decomposition approach because the process involves stoichiometric oxidation of a metal in the liquid metallic composition. Indeed, by appropriate selection of the liquid metallic composition, the carbon-forming reaction is exothermic. Mild reaction temperatures, such as below 400° C., are thus suitable provided that correspondingly low-melting metal compositions are employed, and it is even possible to decompose carbon dioxide to carbon at ambient temperatures in some embodiments.

Secondly, the disclosed methods are typically highly selective to solid carbon. Because relatively low reaction temperatures are suitable, undesirable competing reactions such as the reverse Boudouard reaction, which produces a carbon monoxide by-product, can be minimised or avoided.

Thirdly, the carbon-forming reaction does not rely on a solid-gas or solid-liquid interface which is susceptible to coking. Instead, the reaction is believed to occur either in the liquid phase or at a liquid-gas interface. Thus, the formation of solid products in the process, including carbon, does not cause rapid deactivation and stable conversion rates can be maintained over significant time periods.

Fourthly, because the carbon and metal oxide reaction products are both solids which generally have a density significantly lower than the liquid metallic composition, the reaction products are buoyant and migrate naturally to the surface of the liquid metallic composition. Thus, they do not interfere with ongoing conversion of the carbon oxide reactant in the bulk of the liquid metallic composition and can readily be separated from the residual liquid metallic composition.

The approach disclosed herein also avoids or mitigates a number of the difficulties associated with electrocatalytic of triboelectrochemical decomposition of carbon oxides on liquid metals. Firstly, there is no need for electrical energy input or mechanical energy input sufficient to drive catalytic carbon dioxide decomposition or to regenerate a reaction by-product in situ. Instead, the process is a simple chemical reaction which typically proceeds spontaneously, i.e. without energy input apart from any minor energy needed to produce the dynamic interface between the gas and the liquid metallic composition.

Secondly, there is no need for a liquid carrier, such as a molecular liquid or other non-metallic liquid phase, to carry either a dispersed liquid metal phase or to dissolve the carbon dioxide. Instead, the carbon oxide is directly contacted in gaseous form with the liquid metallic composition at a liquid-gas interface. The absence of any requirement for a molecular liquid also allows a wider range of process conditions to be employed. For example, the methods disclosed herein can be operated at elevated temperatures, e.g. above 200° C., which are not readily compatible with many molecular liquids.

The carbon-forming reaction of the methods disclosed herein is a stoichiometric reaction, in contrast to the catalytic approach which directly converts carbon dioxide to carbon and dioxygen (O₂). However, the metal oxide by-product may optionally be recovered, reduced back to the metallic form and recycled to the liquid metallic composition. In such embodiments, the overall process includes discrete carbon dioxide decomposition and metal oxide reduction steps and can therefore be considered as a chemical looping process where the reactive metal in the liquid metallic composition participates in the reaction cycle but is not consumed. Advantageously, the challenges associated with solid product processing (i.e. carbon formation) and endothermic reaction processing (i.e. metal oxide regeneration) are separated and both steps can be separately optimised in dedicated process units. Moreover, the reduction of the metal oxide can be performed after separating it from the carbon product, so that regeneration of the metal is not confounded by the presence of irreducible solid materials.

In accordance with a first aspect the invention provides a method of reducing a gaseous carbon oxide to carbon, the method comprising mixing a gas comprising a gaseous carbon oxide with a liquid metallic composition by producing a dynamic interface between the gas and the liquid metallic composition, wherein the liquid metallic composition is not dispersed as droplets in a liquid carrier during the mixing and wherein the gaseous carbon oxide reacts stoichiometrically with at least one metal in the liquid metallic composition to form carbon and metal oxide.

In some embodiments, producing the dynamic interface between the gas and the liquid metallic composition comprises at least one selected from the group consisting of bubbling the gas through the liquid metal composition, mechanically agitating the liquid metal composition in the presence of the gas and spraying droplets of the liquid metal composition through the gas.

In some embodiments, the liquid metallic composition is a liquid at 600° C., or at 400° C., or at 200° C., such as at 100° C., for example at room temperature.

In some embodiments, the gas is mixed with the liquid metallic composition at a reaction temperature of less than 600° C., such as at less than 500° C.

In some embodiments, the gas is mixed with the liquid metallic composition at a reaction temperature of less than 400° C.

In some embodiments, the gas is mixed with the liquid metallic composition at a reaction temperature of at least 200° C.

In some embodiments, the gas comprises the gaseous carbon oxide in an amount of at least 0.1 vol. %, such as at least 1 vol. %, for example at least 10 vol. %.

In some embodiments, the method further comprises regenerating the metal oxide to reduced metal in a sequential process step to the formation of the carbon and the metal oxide, and recycling the reduced metal to the liquid metallic composition. Regenerating the metal oxide to reduced metal may comprise electrochemically reducing the metal of the metal oxide to form the reduced metal.

In some embodiments, the method further comprises separating the carbon from the liquid metallic composition.

In some embodiments, the method further comprises separating the metal oxide from the liquid metallic composition.

In some embodiments, the metal oxide and the carbon are separated from the liquid metallic composition as a mixture of solids. The method may further comprise separating the carbon in the mixture from the metal oxide. Separating the carbon in the mixture from the metal oxide may comprise contacting the mixture of solids with a liquid extractant, such as an aqueous acid, dissolving the metal oxide into the liquid extractant, and separating the liquid extractant comprising dissolved metal oxide from the carbon. The method may further comprise subjecting the liquid extractant comprising dissolved metal oxide to electrochemical reduction to form reduced metal.

In some embodiments, the carbon and the metal oxide are separated from the liquid metallic composition by filtration.

In embodiments of the first aspect which operate in a chemical looping mode, the method thus comprises separating the metal oxide from the liquid metal composition; regenerating the metal oxide to reduced metal; and recycling the reduced metal to the liquid metallic composition for further stoichiometric reaction with the gaseous carbon oxide.

In some embodiments, the gas is mixed with the liquid metallic composition in a reactor which contains a liquid column of the liquid metallic composition. Producing a dynamic interface between the gas and the liquid metallic composition may comprise bubbling the gas through the liquid column and/or mechanically agitating the liquid column in the presence of the gas. The carbon and the metal oxide may migrate to an upper surface of the liquid column.

In some embodiments, the liquid metallic composition comprises at least one metal selected from the group consisting of gallium, indium, tin, bismuth, mercury, cadmium, lead, antimony, thallium and zinc.

In some embodiments, the liquid metallic composition comprises gallium. The liquid metallic composition may be an alloy of gallium and indium, such as a binary alloy of gallium and indium, for example eutectic gallium-indium (EGaln). The gaseous carbon oxide may react with at least gallium in the liquid metallic composition to form carbon and gallium oxide.

In some embodiments, the liquid metallic composition is an alloy comprising one or more alloying metals selected from the group consisting of iron, aluminium, cobalt, nickel, copper, zinc, cerium, magnesium, calcium, scandium, titanium, vanadium, chromium, manganese, strontium, yttrium, niobium, molybdenum, barium, gadolinium and hafnium. In some embodiments, the liquid metallic composition is an alloy comprising one or more alloying metals selected from the group consisting of Ce, Mg, Al, Ca, Sc, Ti, V, Cr, Mn, Fe, Sr, Y, Nb, Mo, Ba, Gd and Hf. The one or more alloying metals may be present in an amount of less than 10 wt. %.

In some embodiments, the gaseous carbon oxide reacts with at least one of the alloying metals to form carbon and an oxide of the alloying metal.

In some embodiments, the one or more alloying metals comprise iron, which may be present in an amount of less than 10 wt. %.

In some embodiments, the gaseous carbon oxide comprises carbon dioxide.

In some embodiments, the gaseous carbon oxide is reduced to carbon with a selectivity of at least 90%, such as at least 95%, for example substantially 100%.

In some embodiments, the carbon comprises graphitic carbon.

In accordance with a second aspect the invention provides a chemical looping process for reducing a gaseous carbon oxide to carbon, the process comprising: mixing a gas comprising a gaseous carbon oxide with a liquid metallic composition by producing a dynamic interface between the gas and the liquid metallic composition, wherein the gaseous carbon oxide reacts stoichiometrically with at least one metal in the liquid metallic composition to form carbon and metal oxide; separating the metal oxide from the liquid metal composition; regenerating the metal oxide to reduced metal; and recycling the reduced metal to the liquid metallic composition for further stoichiometric reaction with the gaseous carbon oxide.

The liquid metallic composition is typically not dispersed as droplets in a liquid carrier during the mixing. It will be appreciated that various embodiments of the second aspect may generally include features as disclosed herein in the context of embodiments of the first aspect.

In accordance with a third aspect the invention provides a system for reducing a gaseous carbon oxide to carbon, the system comprising: a source of gas comprising a gaseous carbon oxide; and a reactor containing a liquid metallic composition, the reactor configured to receive the gas from the source and to mix the gas with the liquid metallic composition by producing a dynamic interface between the gas and the liquid metallic composition, wherein the liquid metallic composition is not dispersed as droplets in a liquid carrier during the mixing, wherein in use the gaseous carbon oxide reacts stoichiometrically with at least one metal in the liquid metallic composition to form solid products comprising carbon and metal oxide.

In some embodiments, the reactor is configured to produce the dynamic interface between the gas and the liquid metallic composition by at least one selected from the group consisting of bubbling the gas through the liquid metal composition, mechanically agitating the liquid metal composition in the presence of the gas and spraying droplets of the liquid metal composition through the gas.

In some embodiments, the reactor contains a liquid column of the liquid metallic composition, wherein in use the solid products migrate to an upper surface of the liquid column. The reactor may be configured to mix the gas with the liquid metallic composition by bubbling the gas through the liquid column and/or mechanically agitating the liquid column in the presence of the gas.

In some embodiments, the system further comprises a solid-liquid separator to separate the solid products from the liquid metallic composition. The solid-liquid separator may comprise a filter.

In some embodiments, the system further comprises a carbon recovery unit to separate the carbon in the solid products from the metal oxide. The carbon recovery unit may receive the solid products from the solid-liquid separator. The carbon recovery unit may be configured to dissolve the metal oxide in a liquid extractant, such as an aqueous acid, and to separate the liquid extractant comprising dissolved metal oxide from the carbon.

In some embodiments, the system further comprises a metal reduction unit to reduce the metal of the metal oxide to form a reduced metal. The metal reduction unit may receive the liquid extractant comprising dissolved metal oxide from the carbon recover unit for reduction. The system may be configured to recycle the reduced metal from the metal reduction unit to the liquid metallic composition in the reactor. The metal reduction unit may comprise an electrochemical cell configured to electrochemically reduce the metal of the metal oxide to form the reduced metal.

Thus, in embodiments of the third aspect suitable for operating in a chemical looping mode, the system comprises a metal reduction unit to reduce the metal of the metal oxide, after separation of the solid products from the liquid metallic composition, to form a reduced metal, wherein the system is configured to recycle the reduced metal from the metal reduction unit to the liquid metallic composition in the reactor.

In some embodiments, the liquid metallic composition comprises at least one metal selected from the group consisting of gallium, indium, tin, bismuth, mercury, cadmium, lead, antimony, thallium and zinc.

In some embodiments, the liquid metallic composition comprises gallium. The liquid metallic composition may be an alloy of gallium and indium, such as a binary alloy of gallium and indium, for example eutectic gallium-indium (EGaln).

In some embodiments, the liquid metallic composition is an alloy comprising one or more alloying metals selected from the group consisting of iron, aluminium, cobalt, nickel, copper, zinc, cerium, magnesium, calcium, scandium, titanium, vanadium, chromium, manganese, strontium, yttrium, niobium, molybdenum, barium, gadolinium and hafnium. In some embodiments, the liquid metallic composition is an alloy comprising one or more alloying metals selected from the group consisting of Ce, Mg, Al, Ca, Sc, Ti, V, Cr, Mn, Fe, Sr, Y, Nb, Mo, Ba, Gd and Hf. The one or more alloying metals may be present in an amount of less than 10 wt. %.

In some embodiments, the one or more alloying metals comprise iron, which may be present in an amount of less than 10 wt. %.

In accordance with a fourth aspect the invention provides a chemical looping system for reducing a gaseous carbon oxide to carbon, the system comprising: a source of gas comprising a gaseous carbon oxide; a reactor containing a liquid metallic composition, the reactor configured to receive the gas from the source and to mix the gas with the liquid metallic composition by producing a dynamic interface between the gas and the liquid metallic composition, wherein in use the gaseous carbon oxide reacts stoichiometrically with at least one metal in the liquid metallic composition to form solid products comprising carbon and metal oxide; and a metal reduction unit to reduce the metal of the metal oxide, after separation of the solid products from the liquid metallic composition, to form a reduced metal, wherein the system is configured to recycle the reduced metal from the metal reduction unit to the liquid metallic composition in the reactor.

The liquid metallic composition is typically not dispersed as droplets in a liquid carrier during the mixing. It will be appreciated that various embodiments of the fourth aspect may generally include features as disclosed herein in the context of embodiments of the third aspect.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 is a schematic representation of a system, including a bubble column reactor containing a liquid metallic composition, for reducing a gaseous carbon oxide to carbon according to some embodiments of the invention.

FIG. 2 is a block flow diagram of a system for reducing a gaseous carbon oxide to carbon, with regeneration and recycling of the metal oxide by-product to the liquid metallic composition in the reactor, according to some embodiments of the invention.

FIG. 3 is a block flow diagram of a system for reducing a gaseous carbon oxide to carbon which uses a sacrificial metal reductant in the liquid metallic composition, according to some embodiments of the invention.

FIG. 4 schematically depicts the laboratory-scale bubble column reactor system used in the Examples.

FIG. 5 is a graph which shows the carbon production rate obtained by bubbling a gas comprising CO₂ through a column of EGaln liquid metal at 200° C. in Example 2.

FIG. 6 is a graph which shows the carbon production rate and carbon selectivity obtained by bubbling a gas comprising CO₂ through a column of liquid gallium at 200° C. in Example 3.

FIG. 7 is a graph showing the carbon production rate and carbon selectivity obtained by bubbling a gas comprising CO₂ through a column of EGaln liquid metal at different temperatures between 100° C. and 500° C. in Example 4.

FIG. 8 is an Arrhenius plot for the carbon decomposition reactions performed by bubbling a gas comprising CO₂ through a column of EGaln liquid metal at different temperatures between 100° C. and 500° C. in Example 4.

FIG. 9 shows XPS spectra in the Ga 3d region taken on the surface of EGaln liquid metal, before and after exposure to CO₂ in Example 5.

FIG. 10 shows XPS spectra in the C 1s region taken on the surface of EGaln liquid metal, before and after exposure to CO₂ in Example 5.

FIG. 11 shows the Raman spectrum of a graphitic carbon product produced by decomposing carbon dioxide on EGaln liquid metal, as measured in Example 6.

FIG. 12 is a graph which compares the carbon production rate obtained by bubbling gases comprising either CO or CO₂ through a column of EGaln liquid metal at 200° C. in Example 7.

FIG. 13 is a graph which compares the carbon production rate obtained by bubbling gas comprising CO₂ through a column of EGaln liquid metal at 200° C., with or without an iron additive, in Example 8.

FIG. 14 is a graph which compares the carbon production rate obtained by bubbling gas comprising CO₂ through a column of EGaln liquid metal, with or without varying alloy metals, at 200° C. or 400° C. in Example 9.

FIG. 15 shows the X-Ray Diffraction spectrum of EGaln liquid metal containing 5 wt % iron after contact with carbon dioxide to produce carbon, showing the presence of FeGa₃ intermetallic alloys, as measured in Example 9.

FIG. 16 shows XPS spectra in the Fe 2p region taken on the surface of EGaln liquid metal containing alloyed iron, after exposure to CO₂ in Example 10.

FIG. 17 is a graph which compares the current-potential response curve obtained by electroreduction of an aqueous acid solution comprising Ga³⁺ ions against an equivalent acid solution without metal ions, as measured in Example 9.

### DETAILED DESCRIPTION

The present invention relates to a method of reducing a gaseous carbon oxide, i.e. carbon dioxide or carbon monoxide, to elemental carbon. The method comprises mixing a gas comprising the gaseous carbon oxide with a liquid metallic composition by producing a dynamic interface between the gas and the liquid metallic composition. Under such conditions, the gaseous carbon oxide reacts stoichiometrically with at least one metal in the liquid metallic composition to form carbon and a metal oxide by-product.

### Gas Comprising a Gaseous Carbon Oxide

The gas which is mixed with the liquid metallic composition comprises a gaseous carbon oxide, which may include carbon dioxide, carbon monoxide, or mixtures of carbon dioxide and carbon monoxide. The gaseous carbon oxide may be present in any amount, for example an amount of at least 0.1 vol. %, or at least 1 vol. %, such as at least 10 vol. %. In some embodiments, the gas is predominantly gaseous carbon oxide, for example above 50 vol. %, or is substantially entirely composed of gaseous carbon oxide.

The gas may include other gaseous components, for example inert gases such as dinitrogen (N₂) or argon. Other molecules such as dihydrogen (H₂), low molecular weight hydrocarbons (e.g. methane, ethane, ethylene), methanol, ethanol, acetic acid, H₂S, SOx, NOₓ, H₂O and the like may also be present, depending on the source of the gas. In some embodiments, the gas comprises little or no dioxygen (O₂), which might react preferentially with the liquid metallic composition. In some embodiments, the gas comprises less than 1 vol %, preferably less than 0.1 vol %, of O₂. In some embodiments, the gas comprises less than 1 vol %, preferably less than 0.1 vol %, of H₂O. In some embodiments, the gas does not comprise O₂ or H₂O.

### Liquid Metallic Composition

The gas comprising the gaseous carbon oxide is mixed with a liquid metallic composition. As used herein, a liquid metallic composition refers to a metallic composition comprising one or more metals (i.e. metallic elements) in the molten state. Liquid metallic compositions include both pure liquid metals (PLMs) comprising a single metal element, and alloyed liquid metals (ALMs), which generally include multiple metal elements. As with solid metals, liquid metallic compositions are characterised by metallic bonding. Metal atoms in the molten state provide electrons to an electron cloud which is shared through the bulk of the metallic composition, surrounding the positively charged metal ions and forming the metallic bonds. The delocalized electrons can freely interact with electric fields, thermal energy and light, thus providing liquid metallic compositions with high electric and thermal conductivity despite the absence of a lattice structure.

The liquid metallic composition of the present disclosure may exist in the molten state at temperatures lower than many common metals. Thus, it may be used at the reaction temperatures preferred for converting gaseous carbon oxide to carbon. In some embodiments, the liquid metallic composition is thus a liquid at 600° C., or at 500° C., i.e. its melting point is below 600° C. or 500° C. respectively. In some embodiments, the liquid metallic composition is a liquid at 400° C., or at 200° C. In some embodiments, it is a liquid at all temperatures between 200° C. and 400° C., which is a favoured temperature range for carbon dioxide conversion. In some embodiments, the liquid metallic composition is a liquid at 100° C., or at room temperature (i.e. about 20° C.). While metallic compositions with such very low melting points are not necessary for the reactions with carbon oxides, they have the added advantage that they can be handled with reduced risk of solidification.

A range of low melting liquid metals have been reported for various chemical processing and heat transfer applications. In principle, any such metallic compositions are suitable for use in the present methods subject to the requirement that they contain at least one metal which is reactive with the gaseous carbon oxide, or that such a metal element can be dissolved in them. Some previously reported pure liquid metals include: gallium (Tₘₑₗₜ=29.8° C.), indium (Tₘₑₗₜ=156.8° C.), tin (Tₘₑₗₜ=231.9° C.), bismuth (Tₘₑₗₜ=271.4° C.) and mercury (Tₘₑₗₜ=−33.8° C.). Higher melting metal elements, such as zinc (Tₘₑₗₜ=419.5° C.) may also be suitable. Non-limiting examples of low melting point alloyed liquid metals include eutectic gallium-indium (EGaln) (Tₘₑₗₜ=15.0° C.) and eutectic gallium-indium-tin (Galinstan) (Tₘₑₗₜ=13.2° C.; T_{freeze}=−19.0° C.).

In some embodiments, the liquid metallic composition comprises at least one metal selected from the group consisting of gallium, indium, tin, bismuth, mercury, cadmium, lead, antimony, thallium and zinc. In some embodiments, the liquid metallic composition comprises gallium. Gallium is considered particularly suitable because of its low melting point and low toxicity. Moreover, the inventors have shown by experiment that elemental gallium in a liquid metallic composition is reactive with gaseous carbon oxides to form carbon and gallium oxide, even at low reaction temperatures. The liquid metallic composition may be pure gallium or a gallium alloy. In some embodiments, the liquid metallic composition is an alloy comprising gallium and indium, for example a binary alloy of gallium and indium such as eutectic gallium-indium (EGaln).

The liquid metallic composition comprises at least one metal which reacts stoichiometrically with the gaseous carbon oxide to form carbon and metal oxide. This reactive metal may be present as a low melting point metal component of the liquid metallic composition. For example, gallium is useful both for its low melting properties and for its reactivity with gaseous carbon oxides. Alternatively, the reactive metal may be an alloying metal which is dissolved in the liquid metallic composition specifically for its reactivity with the gaseous carbon oxide. One example of a suitable metal which is preferentially reactive with carbon dioxide, for example in comparison to gallium, is cerium (Ce). Iron (Fe) and aluminium (Al) are also believed, on the basis of experimental results, to be oxidised by carbon oxides in the presence of gallium. More generally, the range of metals which are expected to be reactive with carbon dioxide when present in a liquid metallic composition, based on calculated reaction enthalpies, include Ce, Mg, Al, Ca, Sc, Ti, V, Cr, Mn, Fe, Sr, Y, Nb, Mo, Ba, Gd and Hf.

In some embodiments, the liquid metallic composition is an alloy comprising one or more low melting metals in combination with one or more alloying metals. The alloying metal may be included to facilitate the decomposition of the gaseous carbon dioxide to carbon, for example by acting as the reactive metal or by catalysing the reaction of the carbon oxide with another metal. In some embodiments, the alloying metal is selected from the group consisting of iron, aluminium, cobalt, nickel, copper, zinc, cerium, magnesium, calcium, scandium, titanium, vanadium, chromium, manganese, strontium, yttrium, niobium, molybdenum, barium, gadolinium, and hafnium. The alloying metal may be present as a minor component of the liquid metallic composition, for example an amount of less than 10 wt. %, or below about 5 wt. %, or below 2 wt. %. This is typically necessary to allow dissolution of the alloying metal in the liquid metallic composition without unacceptably raising the melting point.

In some embodiments, the one or more alloying metals comprise iron, aluminium or cerium, suitably iron, and preferably in an amount of less than 10 wt. %, such as about 5 wt. % or less. The inventors have found by experiment that the addition of iron in an amount of about 5 wt. % to EGaln approximately doubles the rate of carbon formation compared to EGaln lacking the iron. Without wishing to be limited by any theory, it is proposed that the higher reaction rate is obtained either because iron is preferentially oxidised compared to gallium and/or because the iron catalyses the oxidation of the gallium.

The use of alloying metals which are preferentially oxidised by the gaseous carbon oxide, in comparison to the low melting metal components of the liquid metallic composition, may provide the opportunity in some scenarios to use metal additives as sacrificial reductants. The metal additive is dissolved in the liquid metallic composition, oxidised to the metal oxide form by the carbon oxide, and removed from the process. Advantageously, the inventory of low melting metals in the liquid metallic composition is thus not depleted, and the sacrificial metal additive may be replenished as needed. This may be an attractive option for metals such as iron which can be obtained from low cost sources, such as scrap iron.

Alternatively, as will be explained in greater detail hereafter, the metal oxide produced by stoichiometric reaction of metal with the gaseous carbon oxide is recovered and regenerated to form reduced metal for recycling to the liquid metal composition. In such a chemical looping process, the metal is thus not consumed.

In use, the liquid metallic composition may be present as a single phase liquid. However, it is not excluded that the liquid metallic composition comprises a solid component, such as an intermetallic phase, provided that the metallic composition as a whole has a substantially liquid character.

### Mixing Via a Dynamic Interface

The methods of the disclosure involve a step of mixing the gas comprising a gaseous carbon oxide with the liquid metallic composition by producing a dynamic interface between the gas and the liquid metallic composition. The gaseous carbon oxide thus reacts stoichiometrically with at least one metal in the liquid metallic composition to form carbon and metal oxide.

As used herein, a dynamic interface between the gas and the liquid metallic composition means that the carbon oxide, in gaseous form, is directly in contact with the liquid metallic composition at a gas-liquid interface which is renewed during the reaction by exposing fresh metal from the bulk of the liquid metal composition at the interface. This dynamic renewal of the gas-liquid interface is preferably continuous during the ongoing reaction to maintain a pristine metallic surface. The dynamic interface between the gas and the liquid metallic composition may be produced by any suitable means, including passing bubbles of the gas through the liquid metallic composition, by agitating the liquid metallic composition in the presence of the gas so that the surface is continuously disturbed, by repeatedly spraying the liquid metallic composition, for example in droplet form, through the gas, and the like.

It will be appreciated that mass transfer between the gas and the liquid metallic composition may, at least in some circumstances, limit the reaction rate of the carbon oxide conversion. Mass transfer limitations may be reduced or eliminated by known engineering principles, for example by increasing the area of the gas-liquid interface (e.g. by controlling the gas bubble size, by increasing the rate of mechanical agitation or by using gas entraining mixing apparatus) or by increasing the total gas pressure or the partial pressure of the carbon oxide in the gas.

The reaction does not rely on a molecular solvent used to dissolve the gaseous carbon oxide and thus to contact the gaseous carbon oxide with the liquid metallic composition at a liquid-liquid interface. In embodiments, therefore, the gas is mixed with the liquid metallic composition in the absence of an organic solvent. In embodiments, the gas is mixed with the liquid metallic composition in the absence of any molecular liquid, or in the absence of any non-metallic liquid phase.

The liquid metallic composition is typically present as a bulk liquid reaction medium in a reactor. In contrast to prior art approaches, it is therefore neither dispersed as droplets in a liquid carrier (i.e. a molecular liquid or other non-metallic liquid in which the liquid metal composition is immiscible) nor confined to the surface of an electrode, where (in either case) a static metal surface is to be expected.

In some embodiments, therefore, the gas is mixed with the liquid metallic composition in a reactor which contains a liquid column of the liquid metallic composition. As used herein, a liquid column refers to a bulk inventory of liquid metallic composition which fills the reactor to a certain height. In such embodiments, producing a dynamic interface between the gas and the liquid metallic composition may comprise bubbling the gas through the liquid column and/or mechanically agitating the liquid column in the presence of the gas.

An advantage of this arrangement is that the carbon and the metal oxide, which are generally solids with a lower density than liquid metallic composition, will automatically migrate to the upper surface of the liquid column. The solid products are thus continuously disengaged from the dynamic gas-liquid interface, and can easily be removed from the liquid metallic composition.

The mixing is conducted at a temperature suitable to obtain the desired reaction between the gaseous carbon oxide and a reactive metal in the liquid metallic composition. In some embodiments, the gas is mixed with the liquid metallic composition at a reaction temperature of less than 600° C., or less than 500° C., or less than 400° C. The inventors have found by experiment that a higher reaction temperature increases the rate of carbon oxide conversion, but that the selectivity to carbon may deteriorate above a threshold temperature between 400° C. and 500° C. where the reverse Boudouard reaction initiates.

In some embodiments, the gas is mixed with the liquid metallic composition at a reaction temperature of at least 200° C. The methods disclosed herein can advantageously be implemented at such high temperatures because no molecular liquid reaction medium is required. In some embodiments, the gas is mixed with the liquid metallic composition at a reaction temperature in the range of about 200° C. to about 400° C.

The gas may be mixed with the liquid metallic composition at ambient pressure. However, it will be appreciated that higher reaction rates may be obtained at higher total pressures and higher carbon oxide partial pressures.

The mixing of the gas with the liquid metallic composition at the dynamic gas-liquid interface results in stoichiometric reaction of the gaseous carbon oxide with a metal in the liquid metallic composition to form carbon and metal oxide. The reaction rate is enhanced by the dynamic mixing process which maintains a pristine metal surface. In contrast, contact of the gas with a static surface of the liquid metallic composition is expected to produce limited or no reaction because of mass transfer limitations and the accumulation of the solid reaction products at the gas-liquid interface.

The reaction is a stoichiometric reaction between the gaseous carbon oxide and at least one metal in the liquid metallic composition to form carbon and metal oxide. In other words, the reacting metal in the liquid metallic composition is oxidised in a stoichiometric chemical reaction, with each reacting metal atom converted to a corresponding metal oxide according to the expected stoichiometry of the reaction with the carbon oxide. It is believed that there is little or no spontaneous or triboelectrochemical reduction of the metal oxide to regenerate reduced metal in situ and produce molecular oxygen (O₂). In at least some embodiments, therefore, no O₂ is produced when the gaseous carbon oxide reacts stoichiometrically with at least one metal in the liquid metallic composition to form carbon and metal oxide. There is no need to mechanically or electrically stimulate the liquid metallic composition for the purposes of reducing the metal oxide in situ. In embodiments, therefore, the liquid metallic composition is not stimulated by sonication (e.g. by ultrasonication) during the reaction. The reaction is also not driven by in situ electrochemical reduction of the metal oxide by-product. In embodiments, therefore, no electrical current is passed through the liquid metallic composition during the reaction.

In some embodiments, the gaseous carbon oxide is reduced to carbon with a selectivity of at least 90%, or at least 95%, or substantially 100%. It has been found that very high selectivity can be obtained by maintaining the reaction temperature below a threshold temperature where competing reactions, such as the reverse Boudouard reaction, become significant. In some embodiments, the carbon product comprises graphitic carbon. It is expected that the carbon morphology can be controlled to an extent based on the reaction conditions. The carbon product may thus also be amorphous, partially oxidised, sheet-like or scroll-like.

### Separation

The method of the disclosure may further comprise a step of separating the carbon product from the liquid metallic composition and/or a separating the metal oxide by-product from the liquid metallic composition.

The metal oxide and the carbon are typically separated from the liquid metallic composition as a mixture of solids. In embodiments where the reaction takes place in a reactor containing a liquid column of the liquid metallic composition, the solid reaction products (including carbon and the metal oxide) co-accumulate at or above the surface of the liquid column, typically in a discrete porous layer which grows in thickness as the reaction progresses. The mixture of solid products can thus be separated from the liquid metallic composition by simply removing the solids from the liquid surface. It is envisaged that this may be performed continuously during the reaction by suitable reactor design. Alternatively, the carbon and/or the metal oxide may be separated from the liquid metallic composition by any suitable means, for example by filtration at the end of a reaction period.

Separation of the carbon from the liquid metallic composition, typically together with the metal oxide, can be achieved in a number of ways. In some embodiments, the mixed solids are skimmed off the surface of the liquid metallic column. This can be achieved in a gravitation-assisted method, for example where the reactor is designed such that the solids spill over from the vessel which retains the liquid metallic column for transfer to the next unit operation. Alternatively, a cyclonic separation can be used. Since the carbon produced is typically “fluffy” (low bulk density), an air current created either by positive pressure (blower) or negative pressure (suction) can carry the carbon away via a cyclonic motion. Other means of transporting the solids product, such as screw conveyers, are also envisaged.

In another variation, the reactor contains a second liquid phase which floats on top of the liquid column of liquid metallic composition, as a discrete layer. Suitably, the second liquid phase may be a molten salt phase. Carbon produced in the reactor, which has a lower density than either liquid phase, thus migrates to the upper surface of the second liquid phase, and is thus automatically physically separated from the liquid metal composition by the layer thickness of the second liquid phase.

In some embodiments, the method comprises a step of separating the carbon from the metal oxide, for example as a sequential step after first separating the solid reaction products from the liquid metallic composition. The separation can be performed by any suitable means. In some embodiments, a liquid extractant such as an aqueous acid (e.g. sulfuric or hydrochloric acid) is used to extract the metal oxide from the carbon. The metal oxide dissolves into the liquid extractant and is separated from the residual carbon by a conventional solid-liquid separation technique such as filtration. The carbon may optionally then be subjected to further processing steps to remove residual contaminants and to produce a dry final product.

### Regenerating the Metal

In the methods disclosed herein, the gaseous carbon oxide is reduced to form carbon by a metal in the liquid metallic composition, with the metal consequently being oxidised to form a metal oxide. It will be apparent that the reactive metal element in the liquid metallic composition will therefore gradually be depleted as the reaction progresses. It may thus become necessary to replace all or a portion of the liquid metallic composition in the reactor or to replenish the reactive metal component thereof. In some embodiments, this is done by regenerating the metal oxide to reduced metallic form and returning the reduced metal to the liquid metallic composition. As used herein, a “reduced metal” refers to a metal in the zero valent, i.e. metallic, form.

The metal oxide may be regenerated to reduced metal in a sequential process step to the carbon-forming reaction, i.e. the metal regeneration is conducted as a discrete process step separated from the carbon-forming reaction in time and/or space so that the metal oxidation (during the carbon-forming reaction) and the metal oxide reduction (during the regeneration) do not occur simultaneously under a common set of process conditions. Thus, the reaction conditions and process equipment for the carbon-forming reaction and the metal regeneration reaction can be separately configured and optimised. The sequential regeneration process step may be performed after first separating the metal oxide from the liquid metallic composition, as already disclosed herein. Thus, the metal regeneration step may be conducted in separate process equipment and apart from the liquid metallic composition. Such a process may be considered a chemical looping process, where the reactive metal component of the liquid metal composition is cycled (looped) between reaction and regeneration process steps and is therefore not consumed in the overall process. However, it is not excluded that the metal oxide can be regenerated in the presence of the residual liquid metallic composition, for example as a time-sequential (e.g. intermittent) process step in the same reactor where carbon formation previously took place.

The metal oxide may be regenerated by electrochemically reducing the metal of the metal oxide to form reduced metal for recycling to the liquid metallic composition. In some embodiments, the metal oxide is first dissolved into an aqueous composition, for example an aqueous acid used to separate the carbon from the metal oxide as disclosed herein. The dissolved metal ions in the aqueous composition are then electrochemically reduced to metal on the cathode of an electrochemical cell. The electrochemical reduction route advantageously provides the opportunity to use renewal energy to drive the overall conversion of the gaseous carbon oxide to carbon, without overall consumption of the liquid metallic composition.

The inventors have shown by experiment that gallium ions can be electrochemically reduced to metallic gallium in aqueous electrolytes, because the gallium reduction reaction initiates at a significantly less negative potential than the hydrogen evolution reaction. It is expected that a range of other metals can be similarly regenerated by electrochemical processing as described herein.

Alternatively, the metal oxide may be regenerated in a chemical reduction process. The metal of the metal oxide may be chemically reduced to form the reduced metal, for example using dihydrogen (H₂) or a hydrocarbon such as methane as the reductant.

Although it may be attractive to regenerate and recycle the metal oxide in this way, it should be appreciated that this is not essential in all scenarios. As an alternative, a sacrificial metal suitable to be preferentially oxidised, for example an alloying metal such as iron, aluminium or cerium, may be dissolved in the liquid metallic composition. The resultant metal oxide may then be discarded or otherwise processed without returning it to the liquid metallic composition. The liquid metallic composition may be regenerated as needed, for example continuously or intermittently, by dissolving more of the sacrificial metal into the metallic formulation.

### System for Reducing a Gaseous Carbon Oxide to Carbon

The present invention also relates to a system for reducing a gaseous carbon oxide to carbon. The system comprises a source of gas comprising the gaseous carbon oxide, and a reactor containing a liquid metallic composition. The reactor is configured to receive the gas from the source and to mix the gas with the liquid metallic composition by producing a dynamic interface between the gas and the liquid metallic composition. In use, the gaseous carbon oxide reacts stoichiometrically with at least one metal in the liquid metallic composition to form solid products comprising carbon and metal oxide.

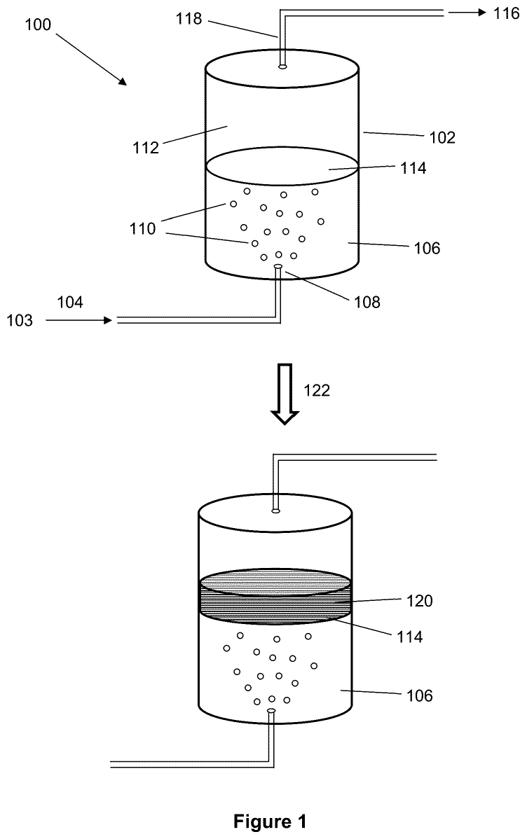

Depicted in FIG. 1 is a schematic representation of system 100 for reducing a gaseous carbon oxide to carbon. System 100 includes a bubble column reactor 102 coupled to a source 103 of a gas 104 comprising a gaseous carbon oxide, for example CO₂. Reactor 102 comprises a column of liquid metallic composition 106, for example gallium or a low melting alloy thereof. Reactor 102 may optionally include either or both a heater to heat liquid metallic composition 104 to the target reaction temperature and a cooler to remove the heat of reaction during the ongoing exothermic reaction (not shown).

In use, gas 104 is fed from source 103 into reactor 102 via gas distributor 108 so that bubbles 110 pass through the column of liquid metallic composition 104 (which may be maintained at a temperature in the range of 200° C. to 400° C.). Preferably, the gas distributor produces small bubbles to maximise the surface area of the dynamic interface between the gas and the liquid metallic composition. As shown in FIG. 1, distributor 108 includes only a single gas inlet, but it will be appreciated that a gas distributor for a bubble column may include multiple gas inlets configured to produce a well-mixed bubbling phase in the column. Reactor 102 is thus configured to mix gas 104 with liquid metallic composition 106 at the dynamic interface between the gas and the liquid metallic composition that is produced when the bubbles pass through the column. After bubbles 110 disengage from the liquid metallic composition into bubble column headspace 112 via upper surface 114, residual gas 116 exits the reactor via exit port 118. Optionally, gas 116 may be recovered and a portion thereof recycled to gas 104 fed to the reactor. The gas thus passes through the column multiple times to increase the overall conversion of the gaseous carbon oxide.

Because gas 104 and liquid metallic composition 106 are contacted at a dynamic (and thus pristine) gas-liquid interface, the gaseous carbon oxide reacts efficiently with at least one metal in liquid metallic composition 104, for example gallium. This results in the formation of solid products 120, which includes carbon and metal oxide (e.g. gallium oxide) as a mixture. The solids products have a lower density than the liquid metallic composition, and thus buoyantly migrate to upper surface 114 of the column. After a period of time, as represented by arrow 122, solid products 120 accumulate as a discrete porous layer on top of upper surface 114 which can easily be separated from the liquid metallic composition when desired.

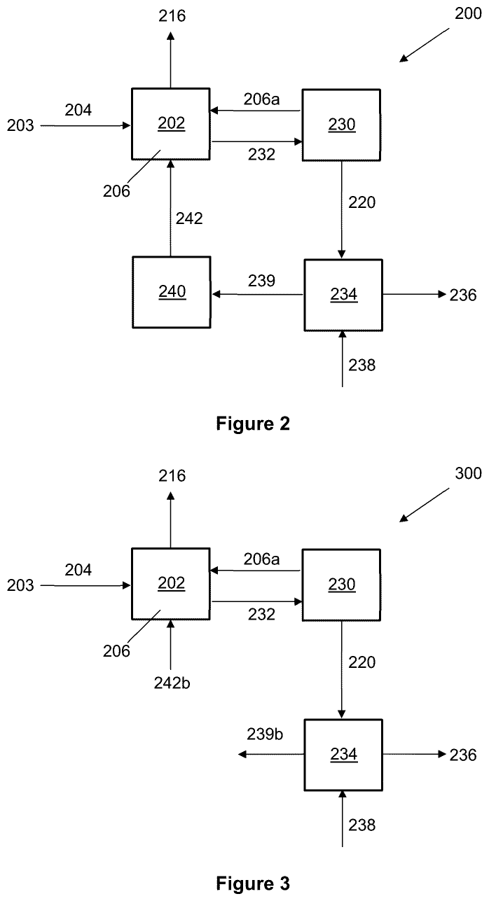

The system of the present disclosure may include further process units configured to separate the solid products from the liquid metallic composition, to separate the carbon in the solid products from the metal oxide and to reduce metal oxide to a reduced metal for recycling to the reactor. Depicted in FIG. 2 is a block flow diagram of system 200 configured in this way.

Chemical looping system 200 includes a reactor 202 configured to receive gas 204 comprising a gaseous carbon oxide, for example CO₂, from source 203. Reactor 202 contains liquid metallic composition 206 and is configured to mix gas 204 with the liquid metallic composition by producing a dynamic interface between the gas and the liquid metallic composition. Reactor 202 may be a bubble column reactor 102, as described herein. Alternatively, it may be any another reactor type configured to produce a suitable dynamic gas-liquid interface, such as an agitated vessel. In use, the gaseous carbon oxide in gas 204 reacts stoichiometrically with at least one metal in the liquid metallic composition to form solid products 220 which include carbon and metal oxide.

Chemical looping system 200 further includes a solid-liquid separator 230 to separate the solid products 220 from the liquid metallic composition 206. The reactor contents 232, including the residual liquid metallic composition 206 and solid products 220, may be transferred to an external solid-liquid separator 230, as depicted in FIG. 2. The external solid-liquid separator may include a filter. The filtered liquid metallic composition 206a is then returned to reactor 202. Alternatively, solid-liquid separator 230 may be integrated with reactor 202 so that the solid products 220 can be directly removed from the reactor while leaving the liquid metallic composition in place, for example by skimming the solids from the surface.

Chemical looping system 200 further includes a carbon recovery unit 234 to receive the solid products 220 from the solid-liquid separator and to separate carbon 236 in the solid products from the metal oxide. This may be done by feeding liquid extractant 238, which may be an aqueous acid (such as aqueous H₂SO₄ or aqueous HCl), to carbon recovery unit 234 for mixing with the solid products 220. The metal oxide component thus dissolves in the liquid extractant and the metal-bearing liquid extractant 239 is then separated from the carbon, for example by filtration. Carbon 236, which may be graphitic in nature, may optionally be further processed to remove residual impurities, and then exits the process as a final product.

Chemical looping system 200 further includes a metal reduction unit 240 to receive the metal of the metal oxide from carbon recovery unit 234, for example in metal-bearing liquid extractant 239, and to reduce the metal ions therein to form reduced metal 242. The metal reduction unit may include an electrochemical cell configured to electrochemically reduce the metal ions to the reduced metal. Alternatively, the metal reduction unit includes a reduction reactor configured to chemically reduce the metal of the metal oxide to the reduced metal, for example with a reductant such as dihydrogen or a hydrocarbon (such as methane). The reduced metal 242 produced in metal reduction unit 240 is then recycled to the liquid metallic composition 206 in reactor 202.

In chemical looping system 200, the reactive metal in the liquid metallic composition is sequentially oxidised, reduced and recycled to the liquid metallic composition in the reactor. Advantageously, the reactive metal is thus not consumed in the overall process. A further advantage of system 200 is that the carbon oxide decomposition reaction, which produces a solid carbon product, is separated from metal reduction reaction, where the energy to drive the overall endothermic reaction must be introduced. Thus, both reactions can be separately optimised in dedicated process units.

It will be appreciated that system 200 may be operated step-wise in a sequence of batch reactions, or continuously, or any combination thereof. For example, reactor 202 may be operated continuously or semi-continuously, with either continuous or intermittent removal of solid products 220 and reintroduction of reduced metal 242. The solid products can be processed into the final carbon product and the regenerated metal in batch, semi-continuous or continuous processing.

In a variation, depicted in FIG. 3 as system 300, metal reduction unit 240 is omitted. The reactive metal in liquid metallic composition 206 may thus be a sacrificial reductant metal 242b which is dissolved into liquid metallic composition 206 as needed to replenish the reactive metal content. In reactor 202, metal 242b is preferentially oxidised to metal oxide and thus selectively depleted from the liquid metallic composition. The sacrificial metal leaves the process as oxidised metal product 239b, which is not reduced or recycled to reactor 202.

### EXAMPLES

The present invention is described with reference to the following examples. It is to be understood that the examples are illustrative of and not limiting to the invention described herein.

### Materials

Gallium (Ga) and Indium (In) were supplied by Roto Metals with cited purities of 99.99%. Iron with purity of 97% was used. All supplied chemicals were used as received.

### Example 1. Preparation of EGaln Alloy

Eutectic gallium-indium alloy (EGaln) was prepared by combining stoichiometric quantities of Ga and In (75 wt. % Ga and 25 wt. % In). The composing metals were mixed on a hot plate at about 200° C. (above the melting point of In), until the metals were completely dissolved and appeared well mixed. The alloy was then allowed to cool down naturally. EGaln has a melting point of 15.5° C., and is therefore in the molten state at room temperature.

### Example 2. CO₂ Decomposition on EGaln in a Bubbling Column Reactor

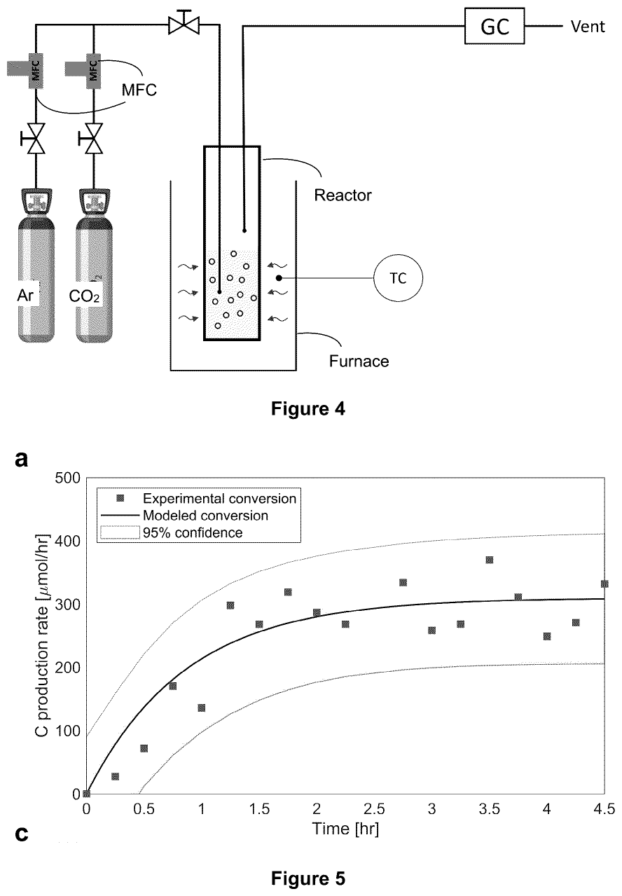

A bubbling column reactor (30 cm in length, 1.0 cm internal diameter) was constructed from quartz to withstand activity tests at high operating temperatures, to give high visibility, and to provide resistance to corrosion (liquid metals are corrosive to other metals). Gas flow into the column was regulated with mass flow controllers (Bronkhorst EL-FLOW; MFC) and checked with non-returning valves to prevent backflow of the reactants. To analyze the gaseous products, continuous gas chromatographic measurements were carried out using a PerkinElmer Clarus 580 online GC. Heating was supplied by an external split furnace equipped with a k-type thermocouple and connected to a temperature controller (TC). A schematic of the reactor system is shown in FIG. 4.

The reactor was charged with EGaln (about 86 g, as prepared in Example 1) and heated to 200° C. A mixture of CO₂ and Ar (1:2 v/v) was bubbled continuously through the liquid metal phase at ambient pressure and a flow rate of about 12 sccm. While a pure feed of CO₂ would be expected to enhance mass transfer in the reaction, the CO₂ feed was balanced with Ar to enable operating within the detection range of the online gas chromatograph.

The formation of carbon, which accumulated at the top of the liquid metal column in the reactor, was visibly observed. The rate of carbon formation increased as a function of time for a period of 150 minutes, and proceeded to reach a steady carbon production rate of 319 μmol/hr (FIG. 5). Apart from the unconsumed CO₂, no other gaseous products were detected in the reactor effluent gas. The reactor and its content were allowed to cool naturally after the reaction, and the carbon product was collected from the top of the liquid metal column for characterization.

A second reaction under the same conditions was conducted for 24 hours to determine if any deactivation was observed over longer time periods. The carbon production rate at 1, 4 and 24 hours is shown in Table 1. It is apparent that no deactivation occurs over at least 24 hours.

TABLE 1

| Time (h) | 1 | 4 | 24 |
|---|---|---|---|
| Carbon production rate (μmol/h) | 183 | 319 | 328 |

### Example 3. CO₂ Decomposition on Ga in a Bubbling Column Reactor

A CO₂ decomposition reaction was conducted following the same method as Example 2, except that pure gallium was used as the liquid metal. Pure gallium has a melting point of 29.8° C., and care was thus taken not to allow solidification of the gallium in the reaction apparatus.

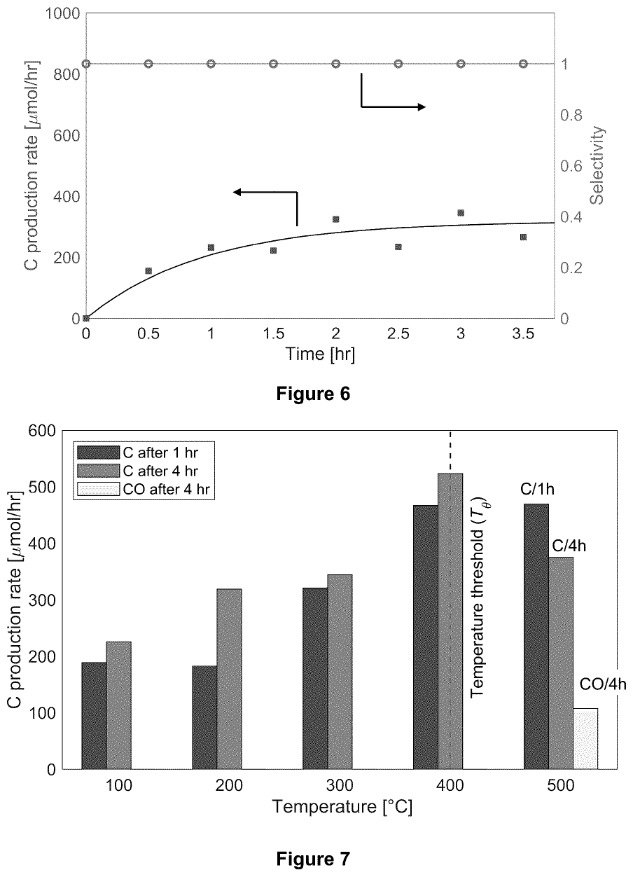

As seen in FIG. 6, similar results were obtained with pure Ga as with EGaln in Example 2. The selectivity to solid carbon was 100%, and a steady state carbon production rate of about 300 μmol/h was again obtained.

The results indicate that gallium is the metallic element which is oxidised in both reactions, as shown in equation (1). It is expected that Ga will be preferentially oxidised over In because of its higher reduction potential.

4Ga+3CO₂→2Ga₂O₃+3C (1)

### Example 4. Investigation of Temperature Effects

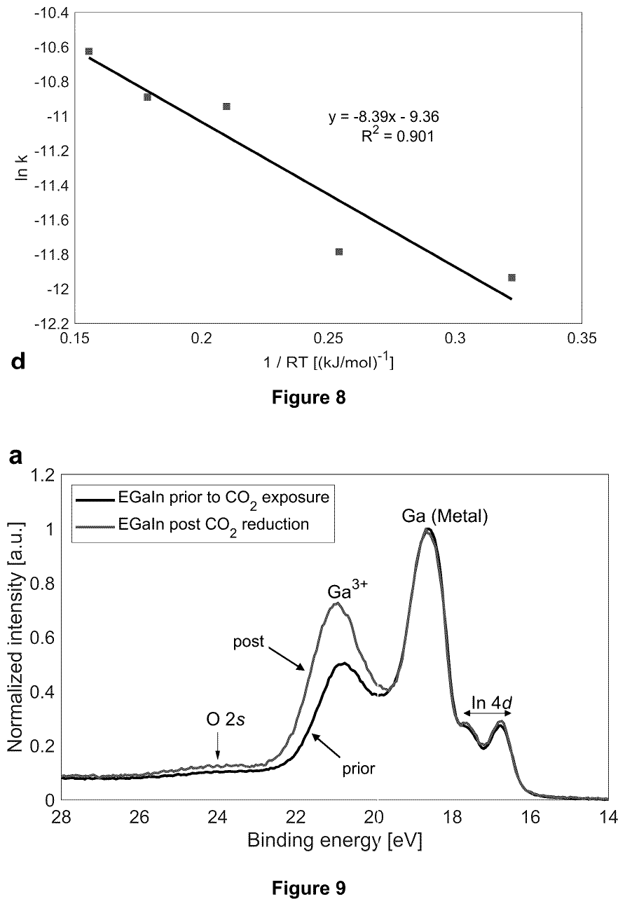

A series of CO₂ decomposition reactions on EGaln was conducted following the same method as Example 2, except that different reaction temperatures, between ambient (room) temperature and 500° C., were used. As seen in FIG. 7, the rate of carbon production increases with temperature. The rate constants (k) were calculated based on the steady state decomposition rate and correlated with temperature through the Arrhenius model, as seen in FIG. 8. The activation energy for the decomposition of CO₂ to solid carbon over EGaln was empirically calculated to be 8.39 KJ/mol. However, it appears that the CO₂ decomposition reaction may be operating in two regimes in this series of experiments. At lower temperatures, i.e. at 100° C. and 200° C., the reaction is under a kinetically controlled regime, whereas the reaction becomes mass transfer limited at higher temperatures.

As also seen in FIG. 7, the selectivity to solid carbon remained quantitative up to 400° C. However, at 500° C., a significant selectivity to carbon monoxide (CO) was observed. This can be attributed to the reverse Boudouard reaction, shown in equation (2). Selectivity to carbon can thus be maximised by remaining below a threshold temperature, between 400° C. and 500° C., at which the reverse Boudouard reaction becomes significant.

3CO₂+C→2CO (2)

It is noted that CO₂ can be activated and decomposed on EGaln even at room temperature. In a 24 hour bubbling column reaction at room temperature, a very substantial amount of carbon was formed above the EGaln column, in the form of a discrete solids layer (carbon mixed with gallium oxide) of greater than 30 mm thickness on top of the column.

### Example 5. Fundamental Investigations-Oxidation of EGaln

To elucidate the mechanism of CO₂ reduction, in-situ XPS analysis was performed on the surface of EGaln liquid metal using a Kratos Axis Supra XPS spectrometer, equipped with a monochromated Al X-ray source (hv=1486.6 eV) and a concentric hemispherical electron analyzer. Obtaining a pristine metallic surface of the EGaln is crucial for drawing meaningful comparisons between the surface prior to and post CO₂ exposure. To that end, the EGaln liquid metal was prepared and loaded in a glovebox under nitrogen flow and transferred into the analysis cell using an air sensitive transporter. Using this loading process and by maintaining ultra-high vacuum conditions, a pristine metal surface was maintained for analysis before exposure to CO₂. Over the course of the analysis, the ambient pressure was maintained in the analysis and reaction chambers below 1.0×10⁻⁸ and 5.0×10⁻⁷ mbar respectively, and the scans were recorded using a 40 eV pass energy. The in-situ operating system replicates the reaction conditions of the bubbling columns experiments by introducing the CO₂/Ar gas feed at atmospheric pressure and heating the satellite gas reaction chamber to 200° C. The surface of EGaln could be examined by XPS before and after CO₂ exposure without breaking vacuum.

The XPS measurements showed that after 30 minutes of exposure to CO₂ the Ga oxide content had increased, whereas In remained metallic: see FIG. 9 which shows an XPS spectrum in the Ga 3d region. The metallic Ga—In ratio at the surface remained constant. The increase in the Ga oxide content is consistent with the finding obtained in the bubbling column experiments, showing that CO₂ reduction can be achieved using pure liquid Ga.

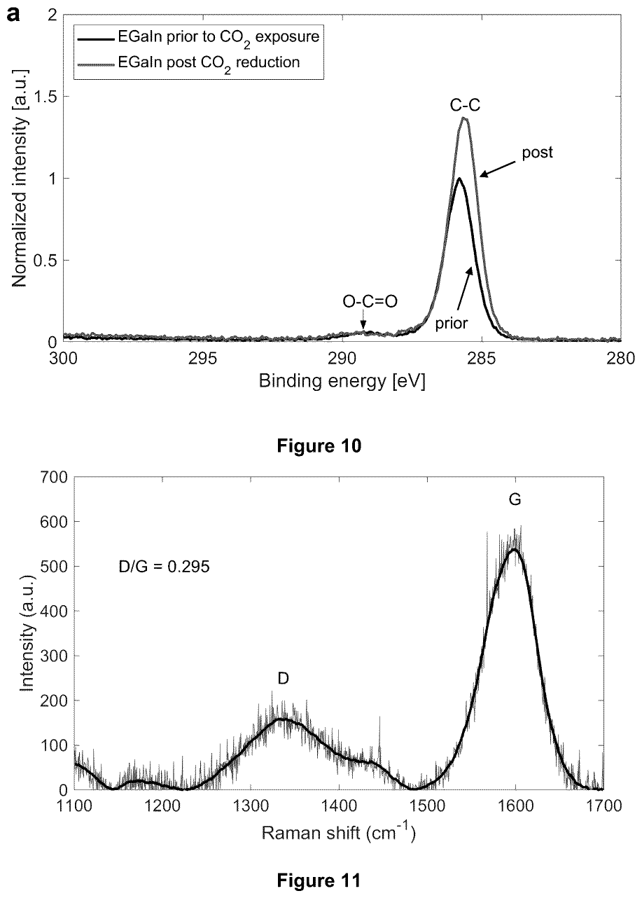

The formation of carbon on the surface was also detected, as seen in FIG. 10 which shows an XPS spectrum in the C1s region. It is noted that adventitious carbon is present on the surface prior to CO₂ exposure. As this could not be avoided, the increase in the carbon peak after CO₂ exposure is taken to be indicative of the formation of carbon in the process. Formation of other carbon species was not detected.

### Example 6. Characterisation of the Solid Product

Scanning Electron Microscope (SEM) images and energy dispersive X-ray (EDX) elemental mappings of the product (200° C., 4 h reaction) obtained post CO₂ decomposition were collected using an FEI Verios 460L equipped with Oxford XMax30 EDS Detector. The images and maps are collected using Elstar in-lens secondary electron detector (TLD-SE) and accelerating voltage of 30 kV, respectively.

Elemental map analysis using EDX showed approximately 1:2 carbon to oxygen ratio, and 2:3 gallium to oxygen ratio in the solid product. These results are consistent with the expected stoichiometry of the gallium mediated decomposition of CO₂ to solid carbon and gallium oxide, as shown in equation (1).

Raman spectra of the solid carbon product were acquired using a Horiba LabRam HR Evolution, equipped with a 532 nm laser. The relative intensity ratio (ID/IG) is calculated based on the measured intensity of the D band (originating at 1325 cm⁻¹) and the G band (originating at 1600 cm⁻¹), as obtained from the Raman spectra.

The relative intensities (I_{D}/I_{G}=0.295), and the position of both the disorder induced D band (at 1325 cm⁻¹) and G band (at 1600 cm⁻¹) in the Raman spectrum are characteristic of graphitic carbon: see FIG. 11.

### Example 7. CO Decomposition on EGaln in a Bubbling Column Reactor

A decomposition reaction was conducted following the same method as Example 2, except that the feed gas was carbon monoxide (instead of carbon dioxide), as a mixture of CO and Ar (1:9 v/v). A comparative reaction was performed using a mixture of CO₂ and Ar (1:9 v/v).

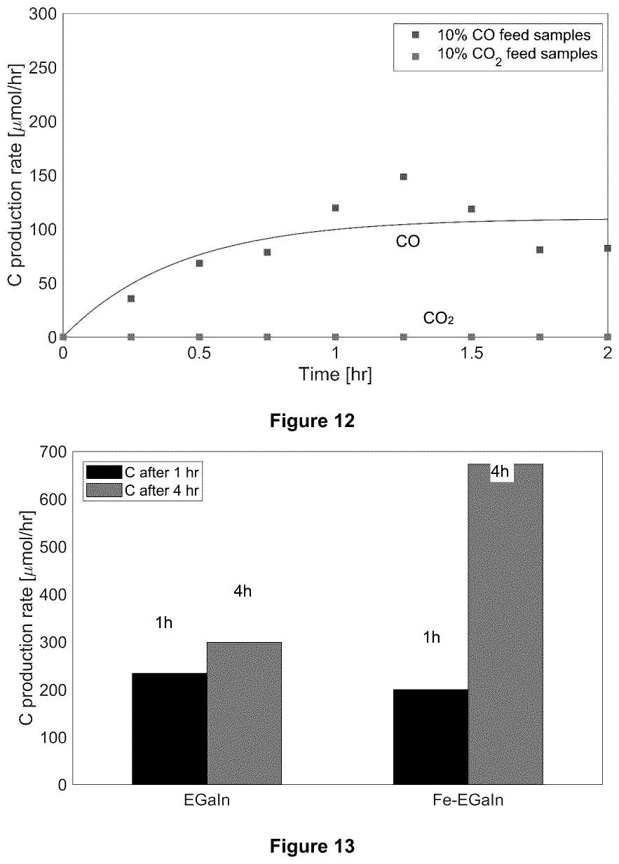

As seen in FIG. 12, CO was found to decompose to carbon at a significantly higher rate than CO₂. At the low reactant concentrations, the conversion rate of CO₂ was too small to detect accurately by GC, although carbon formation was still visually observed. The results demonstrate that both carbon monoxide and carbon dioxide can be decomposed to solid carbon on liquid metal containing gallium. For carbon monoxide, the reaction will be according to equation (3).

2Ga+3CO→Ga₂O₃+3C (3)

### Example 8. CO₂ Decomposition on Ga—In—Fe Alloy in a Bubbling Column Reactor

An iron-containing liquid metal was prepared by dissolving iron metal in EGaln in an amount of 5 wt % Fe (Fe-EGaln). A decomposition reaction was then conducted following the same method as Example 2, except with the Fe-EGaln as the liquid metal in the bubble column reactor.

The results, compared to the EGaln without iron, are shown in FIG. 13. The addition of iron resulted in a doubling of the carbon formation rate at steady state. The selectivity to carbon was again quantitative. Without wishing to be limited by any theory, it is proposed that the higher reaction rate is obtained because iron is preferentially oxidised compared to gallium.

### Example 9. CO₂ Decomposition on Ga—In with Different Alloying Metals Fe Alloy in a Bubbling Column Reactor

Liquid metals containing 5 wt % of an alloying metal, being either zinc, aluminium or iron, were prepared by dissolving the alloying metal in EGaln. Decomposition reactions were then conducted following the same method as Example 2, except with the liquid metal containing alloying metal in the bubble column reactor.

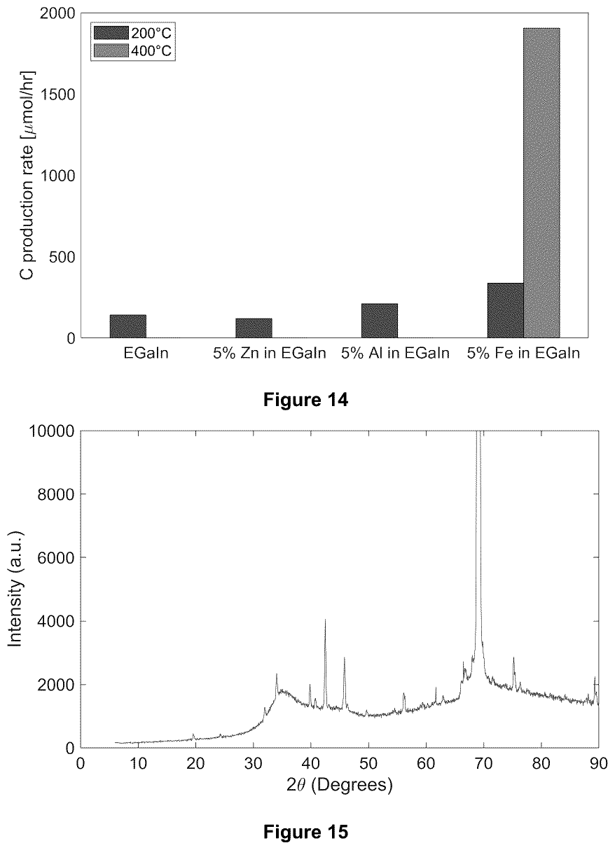

The results, compared to the EGaln without alloying metal, are shown in FIG. 14. At 200° C., the addition of iron or aluminium significantly increased the carbon formation rate at steady state, whereas zinc had no positive effect. The selectivity to carbon was again quantitative. The results are consistent with preferential oxidation of the iron and aluminium by CO₂ compared to gallium.

At 400° C., the rate of carbon formation was extremely high when using the EGaln with 5 wt % Fe, confirming the advantageous effect of using an alloying metal with good susceptibility to oxidation by CO₂. Carbon was also formed when iron was included in amounts of 2.5 and 7.5 wt % in EGaln.

The carbon produced by reacting CO₂ with 5 wt. % Fe in EGaln at 400° C. was analyzed using Raman spectroscopy, showing the D and G bands characteristic of graphitic carbon.

Analysis of the liquid metal alloy post-reaction using X-ray diffraction (XRD) indicated the formation of FeGa₃ intermetallic alloys, as seen in FIG. 15.

### Example 10. Fundamental Investigations-Oxidation of EGaln Containing Iron

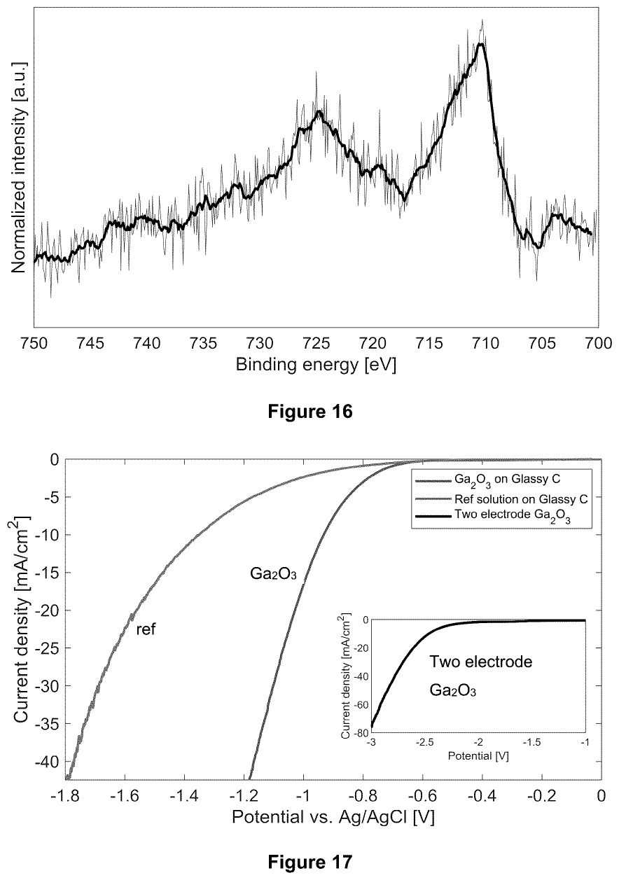

To elucidate the mechanism of CO₂ reduction by EGaln containing 5 wt % iron, in-situ XPS analysis was performed to investigate the species on the surface of the alloyed liquid metal when contacted with CO₂, as described in Example 5. The XPS measurements showed that iron oxide was formed on the surface after 30 minutes of exposure to CO₂: see FIG. 16 which shows an XPS spectrum in the Fe 2p region. The formation of Fe oxides indicates that iron can be oxidised by CO₂ when included in a liquid metallic composition, and suggest that iron is preferentially oxidized compared to gallium when included in a gallium-based liquid metal composition.

### Example 9. Electroreduction of Gallium Oxide

The electroreduction of gallium oxide was carried out on a glassy carbon electrode with an exposed area of 0.28 cm². The gallium oxide was dissolved in an aqueous solution comprising 1M H₂SO₄. Linear sweep voltammetry measurements were performed using a CHI680 Amp Booster. Potentials were measured in an aqueous solution against Ag/AgCl as a reference electrode, and with platinum wire as the counter electrode.

As seen in FIG. 17, the onset potential of the gallium deposition reaction was found at a significantly less negative potential (vs. Ag/AgCl) when compared with the onset of the hydrogen evolution reaction of a gallium-free 1M H₂SO₄ reference solution. This finding highlights the feasibility of regenerating reacted gallium and closing the cycle in a chemical looping process.

Furthermore, gallium reduction was also conducted in a two-electrode system (glassy carbon working electrode, platinum wire electrode as both counter and reference electrode) which resembles a possible implemented process more closely. Here an onset potential of −1.57 V was measured, while a current density of 20 mA/cm² was obtained at −2.5 V. The use of an electrochemical approach to reduce the generated gallium oxide allows for the employment of established reactor designs that are compatible with renewable energy sources.

It was also demonstrated that oxidised gallium ions could be electroreduced to gallium metal from aqueous gallium chloride solutions with high faradaic efficiencies (c.a. 70%). The results demonstrate that gallium oxide could also be extracted into hydrochloric acid for electrolytic regeneration to form gallium metal in a chemical looping process.

Those skilled in the art will appreciate that the invention described herein is susceptible to variations and modifications other than those specifically described. It is understood that the invention includes all such variations and modifications which fall within the spirit and scope of the present invention.

1. A method of reducing a gaseous carbon oxide to carbon, the method comprising mixing a gas comprising a gaseous carbon oxide with a liquid metallic composition by producing a dynamic interface between the gas and the liquid metallic composition, wherein the liquid metallic composition is not dispersed as droplets in a liquid carrier during the mixing and wherein the gaseous carbon oxide reacts stoichiometrically with at least one metal in the liquid metallic composition to form carbon and metal oxide.

2. The method according to claim 1, wherein the liquid metallic composition is a liquid at 400° C.

3. The method according to claim 1, wherein the gas is mixed with the liquid metallic composition at a reaction temperature of less than 500° C.

4. The method according to claim 1, wherein the gas is mixed with the liquid metallic composition at a reaction temperature of at least 200° C.

5. The method according to claim 1, further comprising regenerating the metal oxide to reduced metal in a sequential process step to the formation of the carbon and the metal oxide, and recycling the reduced metal to the liquid metallic composition.

6. The method according to claim 5, wherein regenerating the metal oxide to reduced metal comprises electrochemically reducing the metal of the metal oxide to form the reduced metal.

7. The method according to claim 1, further comprising separating the metal oxide and the carbon from the liquid metallic composition as a mixture of solids.

8. The method according to claim 7, further comprising contacting the mixture of solids with a liquid extractant, dissolving the metal oxide into the liquid extractant, and separating the liquid extractant comprising dissolved metal oxide from the carbon.

9. (canceled)

10. The method according to claim 8, further comprising subjecting the liquid extractant comprising dissolved metal oxide to electrochemical reduction to form reduced metal.

11. The method according to claim 1, wherein the gas is mixed with the liquid metallic composition in a reactor which contains a liquid column of the liquid metallic composition, wherein the carbon and the metal oxide migrate to an upper surface of the liquid column.

12. The method according to claim 11, wherein producing a dynamic interface between the gas and the liquid metallic composition comprises bubbling the gas through the liquid column and/or mechanically agitating the liquid column in the presence of the gas.

13. The method according to claim 1, wherein the liquid metallic composition comprises at least one metal selected from the group consisting of gallium, indium, tin, bismuth, mercury, cadmium, lead, antimony, thallium and zinc.

14. The method according to claim 1, wherein the liquid metallic composition comprises gallium, wherein the gaseous carbon oxide reacts with at least gallium in the liquid metallic composition to form carbon and gallium oxide.

15. (canceled)

16. The method according to claim 1, wherein the liquid metallic composition is an alloy comprising one or more alloying metals selected from the group consisting of Ce, Mg, Al, Ca, Sc, Ti, V, Cr, Mn, Fe, Sr, Y, Nb, Mo, Ba, Gd and Hf, and wherein the gaseous carbon oxide reacts with at least one of the alloying metals to form carbon and an oxide of the alloying metal.

17. The method according to claim 16, wherein the one or more alloying metals comprise iron.

18. A chemical looping process for reducing a gaseous carbon oxide to carbon, the process comprising:
mixing a gas comprising a gaseous carbon oxide with a liquid metallic composition by producing a dynamic interface between the gas and the liquid metallic composition, wherein the gaseous carbon oxide reacts stoichiometrically with at least one metal in the liquid metallic composition to form carbon and metal oxide;
separating the metal oxide from the liquid metal composition;
regenerating the metal oxide to reduced metal; and
recycling the reduced metal to the liquid metallic composition for further stoichiometric reaction with the gaseous carbon oxide.

19. A system for reducing a gaseous carbon oxide to carbon, the system comprising:
a source of gas comprising a gaseous carbon oxide; and
a reactor containing a liquid metallic composition, the reactor configured to receive the gas from the source and to mix the gas with the liquid metallic composition by producing a dynamic interface between the gas and the liquid metallic composition, wherein the liquid metallic composition is not dispersed as droplets in a liquid carrier during the mixing,
wherein in use the gaseous carbon oxide reacts stoichiometrically with at least one metal in the liquid metallic composition to form solid products comprising carbon and metal oxide.

20. A system according to claim 19, wherein the reactor contains a liquid column of the liquid metallic composition, wherein in use the solid products migrate to an upper surface of the liquid column, wherein the reactor is configured to mix the gas with the liquid metallic composition by bubbling the gas through the liquid column and/or mechanically agitating the liquid column in the presence of the gas.

21. (canceled)

22. A system according to claim 19, further comprising a carbon recovery unit to separate the carbon in the solid products from the metal oxide, wherein the carbon recovery unit is configured to dissolve the metal oxide in an aqueous acid liquid extractant, and to separate the liquid extractant comprising dissolved metal oxide from the carbon.

23. The system according to claim 19, further comprising a metal reduction unit to reduce the metal of the metal oxide to form a reduced metal, wherein the system is configured to recycle the reduced metal from the metal reduction unit to the liquid metallic composition in the reactor, wherein the metal reduction unit comprises an electrochemical cell configured to electrochemically reduce the metal of the metal oxide to form the reduced metal.

24-28. (canceled)
